(19) United States
(12) Patent Application Publication
(10) Pub. No.: US 2025/0007383 A1
(43) Pub. Date: Jan. 2, 2025

(54) POWER SUPPLY CIRCUIT AND ASSOCIATED CONTROL CIRCUIT AND CONTROL METHOD

(71) Applicant: Chengdu Monolithic Power Systems Co., Ltd., Chengdu (CN)

(72) Inventors: Yuedong Chen, Chengdu (CN); Junlin Qian, Chengdu (CN)

(21) Appl. No.: 18/754,999

(22) Filed: Jun. 26, 2024

(30) Foreign Application Priority Data
Jun. 27, 2023 (CN) 202310769604.1

(51) Int. Cl. H02M 1/00; H02J 7/00; H02J 7/34; H02M 7/02

(52) U.S. Cl. CPC H02M 1/0022; H02J 7/007182; H02J 7/345; H02M 7/02; H02J 2207/50

(57) ABSTRACT

A control circuit for controlling a power supply voltage of an integrated circuit is provided. The control circuit includes a charging current source. The charging current source receives an input voltage and provides a charging current to a power supply capacitor for generating the power supply voltage. The charging current source starts providing the charging current for charging the power supply capacitor when the input voltage decreases to a charging start threshold voltage and stops providing the charging current when the power supply voltage increases to a charging stop reference voltage. The charging start threshold voltage is adjusted to get a continuous time duration of providing the charging current to be substantially symmetric with respect to a minimum value of the input voltage.

### CROSS-REFERENCE TO RELATED APPLICATIONS

This application claims priority to and the benefit of Chinese Patent Application No. 202310769604.1, filed on Jun. 27, 2023, which is incorporated herein by reference in its entirety.

### TECHNICAL FIELD

The present invention relates generally to electronic circuits, and more particularly but not exclusively to a control circuit used in a power supply circuit for controlling a power supply voltage and associated control methods.

### BACKGROUND OF THE INVENTION

With the increase of smartphone's functions, fast charging technology is born to meet high power consumption requirements. FIG. 1 schematically shows a conventional voltage converting circuit 10 used in a fast-charging power supply. As shown in FIG. 1, an AC voltage Vac is rectified by a bridge rectifier 101 and then filtered by an input capacitor Cbus (not shown) to obtain a DC voltage Vbus. The DC voltage Vbus is provided to a transformer Tr of the voltage converting circuit 10. The duty cycle of a primary side switch M1 coupled to the transformer Tr is controlled by a voltage converting control circuit 102 to control the transferred energy between the primary side and the secondary side of the transformer Tr, thereby realizing the regulation of an output voltage Vout. The voltage converting control circuit 102 is powered by an auxiliary winding Lt. There is a proportional relationship between a power supply voltage Vcc provided by the auxiliary winding Lt and the output voltage Vout. The proportional coefficient is determined by the turns ratio of the auxiliary winding Lt to a secondary winding Ls, i.e., Vcc:Vout=N(Lt):N(Ls), wherein N represents the number of winding turns. It should be appreciated that, the power supply voltage Vcc should be maintained above a lower limit (usually 10V) to ensure the normal operation of the voltage converting control circuit 102. When the output voltage Vout is 3.3V, the turns ratio of the auxiliary winding Lt to the secondary winding Ls should be at least 3:1. However, if the turns ratio of the auxiliary winding Lt to the secondary winding Ls is 3:1, the power supply voltage Vcc is 60V when the output voltage Vout is 20V. In this case, high voltage devices are required in the voltage converting control circuit 102 and more power loss is produced.

### SUMMARY OF THE INVENTION

According to an embodiment of the present invention, a control circuit for controlling a power supply voltage of an integrated circuit is provided. The control circuit includes a charging current source. The charging current source receives an input voltage and provides a charging current to a power supply capacitor for generating the power supply voltage. The charging current source starts providing the charging current for charging the power supply capacitor when the input voltage decreases to a charging start threshold voltage. The charging current source stops providing the charging current when the power supply voltage increases to a charging stop reference voltage. The charging start threshold voltage is adjusted to get a continuous time duration of providing the charging current to be substantially symmetric with respect to a minimum value of the input voltage.

According to another embodiment of the present invention, a power supply circuit for providing a power supply voltage of an integrated circuit is provided. The power supply circuit includes a power supply capacitor and a control circuit. The power supply capacitor has a charging terminal. The control circuit is coupled to the charging terminal of the power supply capacitor and controls the power supply voltage. The control circuit includes a charging current source. The charging current source receives an input voltage and provides a charging current to the power supply capacitor for generating the power supply voltage. The charging current source starts providing the charging current for charging the power supply capacitor when the input voltage decreases to a charging start threshold voltage. The charging current source stops providing the charging current when the power supply voltage increases to a charging stop reference voltage. The charging start threshold voltage is adjusted to get a continuous time duration of providing the charging current to be substantially symmetric with respect to a minimum value of the input voltage.

According to yet another embodiment of the present invention, a method of controlling a power supply voltage is provided. The method has the following steps. A charging current source is controlled to start providing a charging current for charging a power supply capacitor when an input voltage decreases to a charging start threshold voltage. The charging current source is controlled to stop providing the charging current when the power supply voltage increases to a charging stop reference voltage. The charging start threshold voltage is adjusted to get a continuous time duration of providing the charging current to be substantially symmetric with respect to a minimum value of the input voltage.

### BRIEF DESCRIPTION OF THE DRAWINGS

The present invention can be further appreciated with reference to the following detailed description and the appended drawings.

FIG. 1 schematically shows a conventional voltage converting circuit 10 used in a fast-charging power supply.

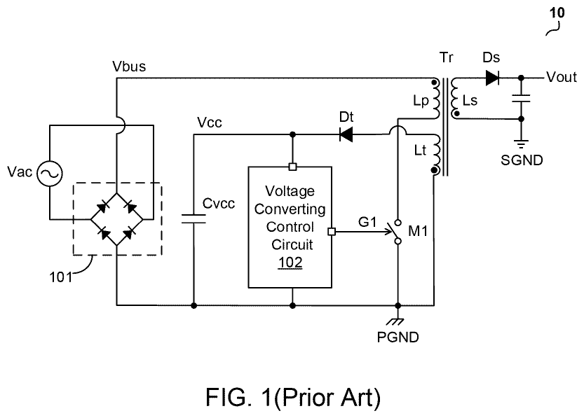

FIG. 2 schematically shows a voltage converting circuit 20 in accordance with an embodiment of the present invention.

FIG. 3 schematically shows a flowchart of a working method 30 of a charging control circuit 23 in accordance with an embodiment of the present invention.

FIG. 4 schematically shows working waveforms of the charging control circuit 23 in accordance with an embodiment of the present invention.

FIG. 5 schematically shows a voltage converting circuit 50 in accordance with an embodiment of the present invention.

FIG. 6 schematically shows a voltage converting circuit 60 in accordance with an embodiment of the present invention.

FIG. 7 schematically shows a voltage converting circuit 70 in accordance with an embodiment of the present invention.

FIG. 8 schematically shows a flowchart of a method 80 of controlling a power supply voltage in accordance with an embodiment of the present invention.

The use of the same reference label in different drawings indicates the same or like components.

### DETAILED DESCRIPTION OF THE INVENTION

Various embodiments of the present invention will be described in detail below, and it should be noted that the embodiments described here are only for illustration. However, the present invention is not limited thereto. In the following description, numerous specific details, such as example circuits and example values for these circuit components, and methods are illustrated in order to provide a thorough understanding of the present invention. It will be apparent for persons having ordinary skill in the art that the present invention can be practiced without one or more specific details, or with other methods, components, materials. In other instances, well-known circuits, materials or methods are not shown or described in detail in order to avoid obscuring the present invention.

Throughout this description, the phrases “in one embodiment”, “in an embodiment”, “in some embodiments”, “in an example”, “in some examples”, “in one implementation”, and “in some implementations” as used to include both combinations and sub-combinations of various features described herein as well as variations and modifications thereof. These phrases used herein does not necessarily refer to the same embodiment, although it may. Additionally, persons having ordinary skill in the art will be appreciated that the drawings provided herein are for illustrative purposes and are not necessarily drawn to scale. The similar elements are provided with similar reference numerals. As used herein, the term “and/or” includes any combinations of one or more of the listed items.

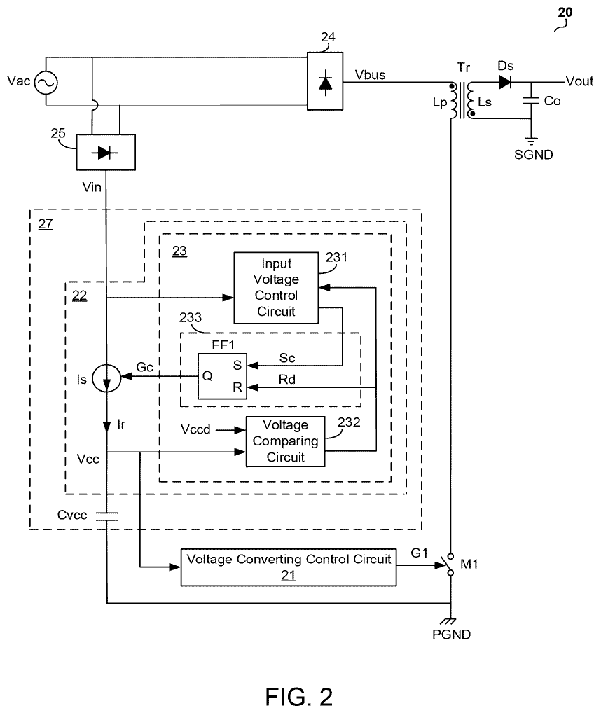

FIG. 2 schematically shows a voltage converting circuit 20 in accordance with an embodiment of the present invention. The voltage converting circuit 20 includes rectifying circuits 24 and 25, a transformer Tr, a primary switch M1, a secondary switch Ds, a voltage converting control circuit 21 and a power supply circuit 27. The rectifying circuit 24 rectifies an AC voltage Vac from an AC power supply and provides a DC voltage Vbus. The DC voltage Vbus is provided to the transformer Tr. The transformer Tr has a primary winding Lp and a secondary winding Ls. The primary switch M1 is coupled to the primary winding Lp. The secondary switch Ds is coupled to the secondary winding Ls. The voltage converting control circuit 21 provides a primary control signal G1 to a control terminal of the primary switch M1, to control the primary switch M1. To be specific, when the primary switch M1 is turned on, the secondary switch Ds is turned off, a current flowing through the primary winding Lp increases, the primary winding Lp stores energy. When the primary switch M1 is turned off, the secondary switch Ds is turned on, the energy stored in the primary winding Lp is transferred to the secondary winding Ls.

The rectifying circuit 25 rectifies the AC voltage Vac from the AC power supply and provides an input voltage Vin having a half-sine wave. The power supply circuit 27 receives the input voltage Vin, and provides a power supply voltage Vcc to power the voltage converting control circuit 21.

In some embodiments, the rectifying circuit 24 includes a first bridge rectifier and an input capacitor, the rectifying circuit 25 includes a second bridge rectifier.

As shown in FIG. 2, the power supply circuit 27 includes a power supply capacitor Cvcc and a power supply control circuit 22. The power supply control circuit 22 includes a charging current source Is and a charging control circuit 23. The power supply capacitor Cvcc has a charging terminal coupled to the charging current source Is and a ground terminal coupled to a primary reference ground PGND. The charging current source Is receives the input voltage Vin and provides a charging current Ir to the power supply capacitor Cvcc. The charging control circuit 23 provides a charging control signal Gc to control the charging current source Is. Under the control of the charging control signal Gc, the charging current source Is charges the power supply capacitor Cvcc to generate the power supply voltage Vcc. It should be appreciated that, both of the charging current source Is and the charging control circuit 23 could be integrated with the voltage converting control circuit 21 in an integrated circuit, and the power supply voltage Vcc could be used for powering the integrated circuit.

In the embodiment shown in FIG. 2, the charging control circuit 23 includes an input voltage control circuit 231, a voltage comparing circuit 232, and a charging control logic circuit 233. The voltage comparing circuit 232 receives the power supply voltage Vcc and a charging stop reference voltage Vccd, and provides a charging stop signal Rd. The input voltage control circuit 231 receives the input voltage Vin and the charging stop signal Rd, and provides a charging set signal Sc. The charging control logic circuit 233 receives the charging set signal Sc and the charging stop signal Rd, and provides the charging control signal Gc to control the charging current source Is. In the embodiment shown in FIG. 2, the charging control logic circuit 233 includes a RS flip-flop FF1. The RS flip-flop FF1 has a set terminal, a reset terminal and an output terminal. The set terminal of the RS flip-flop FF1 is configured to receive the charging set signal Sc. The reset terminal of the RS flip-flop FF1 is configured to receive the charging stop signal Rd. The output terminal of the RS flip-flop FF1 is configured to provide the charging control signal Gc. The charging control signal Gc controls the charging current source Is to start providing the charging current Ir for charging the power supply capacitor Cvcc when the input voltage Vin decreases to a charging start threshold voltage Vt. The charging control signal Gc controls the charging current source Is to stop providing the charging current Ir when the power supply voltage Vcc increases to the charging stop reference voltage Vccd.

The voltage comparing circuit 232 may be a comparator. In one embodiment, when the power supply voltage Vcc is higher than the charging stop reference voltage Vccd, the charging stop signal Rd is enabled. It should be appreciated that, other conventional circuits that could generate signals to indicate that the power supply voltage Vcc increases to the charging stop reference voltage Vccd could also be utilized as the voltage comparing circuit.

The state of the signal may be represented by different voltage levels. For example, a high voltage level is indicative of an enabled state of the signal, and a low voltage level is indicative of a disabled state of the signal. In another example, the high voltage level is indicative of the disabled state of the signal, and the low voltage level is indicative of the enabled state of the signal. In the embodiments of the present invention, other features of the signal could also be utilized to indicate the state of the signal, for example, a rise edge and a fall edge of the signal. It should also be noted that, the enabled states (or disabled state) of different signals do not need to be consistent and could be different from each other.

The input voltage control circuit 231 could be realized by a digital circuit. In other words, functions and working process of the input voltage control circuit 231 could be described by a digital language to generate the digital circuit automatically.

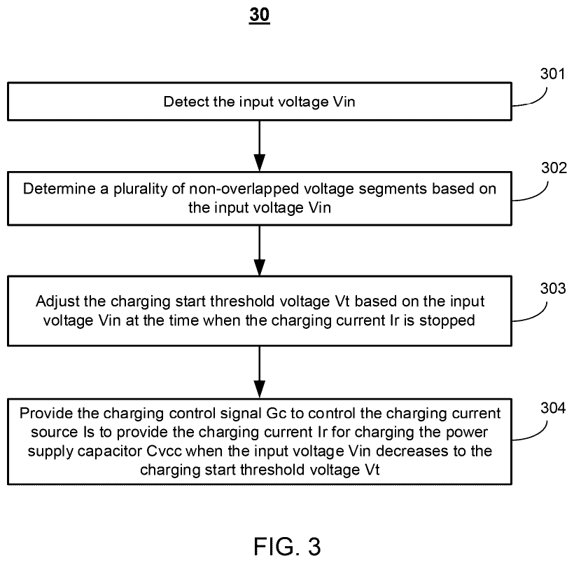

FIG. 3 schematically shows a flowchart of a working method 30 of the charging control circuit 23 in accordance with an embodiment of the present invention. As shown in FIG. 3, the working method 30 includes steps 301-304.

In step 301, the input voltage Vin is detected. In step 302, a plurality of non-overlapped voltage segments are determined based on the input voltage Vin. For example, the plurality of non-overlapped voltage segments could be determined in accordance with a peak value of the input voltage Vin. In step 303, the charging start threshold voltage Vt is adjusted based on the input voltage Vin at the time when the charging current Ir is stopped. In step 304, the charging control signal Gc is provided to control the charging current source Is to provide the charging current Ir for charging the power supply capacitor Cvcc when the input voltage Vin decreases to the charging start threshold voltage Vt. The continuous time duration of providing the charging current Ir is a charging cycle. In other words, the charging cycle starts when the charging current source Is starts providing the charging current Ir and ends when the charging current source Is stops providing the charging current Ir.

The steps of the aforementioned working method 30 could be performed in different orders.

The input voltage Vin is a rectified half-sine wave, which is obtained by rectifying the AC voltage Vac from the AC power supply. The period of the input voltage Vin is half of the period of the AC voltage Vac, and the frequency of the input voltage Vin is twice of the frequency of the AC voltage Vac. The peak value of the input voltage Vin is substantially fixed when the AC voltage Vac is determined. It should be appreciated that, the charging start threshold voltage Vt in different charging cycles could be adjusted adaptively. The charging start threshold voltage Vt in each charging cycle corresponds to one of the plurality of voltage segments. In other words, each voltage segment of the plurality of voltage segments could have a corresponding charging start threshold voltage Vt. Through adjusting the charging start threshold Vt, the charging cycle (i.e., a continuous time duration of providing the charging current Ir) could be controlled to be substantially symmetric with respect to a minimum value of the input voltage Vin. It should be understood that “substantially” is a term of art, and is meant to convey the principle that relationship such simultaneity or perfect synchronization cannot be met with exactness, but only within the tolerances of the technology available to a practitioner of the art under discussion. Therefore, the power dissipation could be reduced.

In some embodiments of the present invention, the peak value of the input voltage Vin is used to determine a plurality of voltage segments W1-Wn, wherein n is an integer greater than 1. In one embodiment, when the peak value of the input voltage Vin is 100V, n=5, a first voltage segment W1 is 12V˜15V, a second voltage segment W2 is 9V˜12V, a third voltage segment W3 is 6V˜9V, a fourth voltage segment W4 is 3V˜6V, a fifth voltage segment W5 is 0V˜3V. Accordingly, the charging start threshold voltage Vt could be set to a maximum value of a corresponding voltage segment. For example, the charging start threshold voltage Vt in the first voltage segment W1 is 15V, the charging start threshold voltage Vt in the second voltage segment W2 is 12V, the charging start threshold voltage Vt in the third voltage segment W3 is 9V, the charging start threshold voltage Vt in the fourth voltage segment W4 is 6V, and the charging start threshold voltage Vt in the fifth voltage segment W5 is 3V.

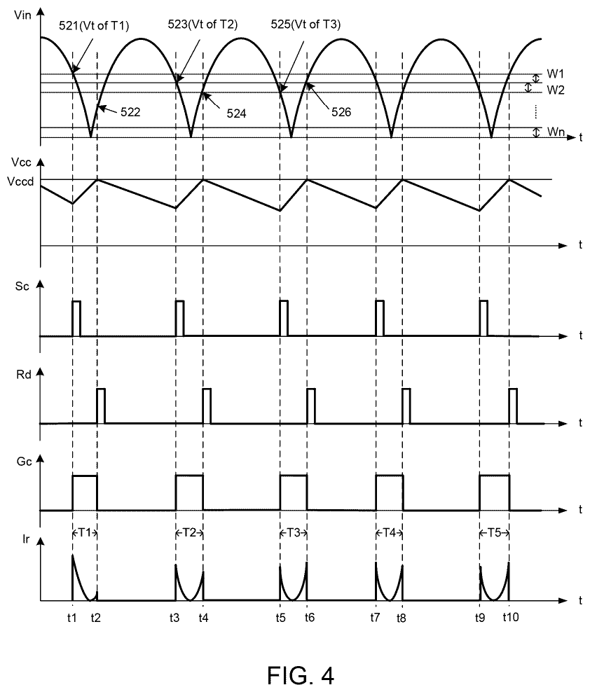

FIG. 4 schematically shows working waveforms of the charging control circuit 23 in accordance with an embodiment of the present invention. The working principle of the charging control circuit 23 is described below with reference to FIGS. 2-4.

As shown in FIG. 4, a lower part of the input voltage Vin is divided into the plurality of voltage segments W1-Wn. At time t1, the input voltage Vin decreases to the charging start threshold voltage Vt. The input voltage control circuit 231 provides the charging set signal Sc to set the RS flip-flop FF1. The RS flip-flop FF1 provides the charging control signal Gc to control the charging current source Is to provide the charging current Ir. The power supply capacitor Cvcc is charged, so the power supply voltage Vcc increases.

At time t2, the power supply voltage Vcc increases to the charging stop reference voltage Vccd, the voltage comparing circuit 232 provides the charging stop signal Rd to reset the RS flip-flop FF1. The RS flip-flop FF1 provides the charging control signal Gc to control the charging current source Is to stop providing the charging current Ir. A charging cycle T1, as shown in FIG. 4, refers to the continuous time duration (from t1 to t2) of providing the charging current Ir. In the charging cycle T1, the maximum value of the first voltage segment W1 is used as the charging start threshold voltage Vt (labelled as 521). The input voltage control circuit 231 detects the input voltage Vin at time t2, and compares the detected value (labelled as 522) with the charging start threshold voltage Vt (labelled as 521). If the value 522 is lower than the value 521, the charging start threshold voltage Vt in a subsequent charging cycle T2 (from t3 to t4) is reduced, e.g., adjusted to the maximum value of the second voltage segment W2. For example, in one embodiment, the charging start threshold voltage Vt in the current charging cycle T1 is 15V and the charging start threshold voltage Vt in the subsequent charging cycle T2 is adjusted to the maximum value of the second voltage segment W2 (i.e., 12V).

At time t3, the input voltage Vin decreases to the charging start threshold voltage Vt (labelled as 523). The input voltage control circuit 231 provides the charging set signal Sc to set the RS flip-flop FF1. The RS flip-flop FF1 provides the charging control signal Gc to control the charging current source Is to provide the charging current Ir. The subsequent charging cycle T2 starts. The power supply capacitor Cvcc is charged, so the power supply voltage Vcc increases.

At time t4, the power supply voltage Vcc increases to the charging stop reference voltage Vccd, the voltage comparing circuit 232 provides the charging stop signal Rd to reset the RS flip-flop FF1. The RS flip-flop FF1 provides the charging control signal Gc to control the charging current source Is to stop providing the charging current Ir. The input voltage control circuit 231 detects the input voltage Vin at time t4, and compares the detected value (labelled as 524) with the charging start threshold voltage Vt (labelled as 523). As shown in FIG. 4, if the value 524 is lower than the value 523, the charging start threshold voltage Vt in a subsequent charging cycle T3 (from t5 to t6) is reduced, e.g., adjusted to the maximum value of the third voltage segment W3. For example, in one embodiment, the charging start threshold voltage Vt in the current charging cycle T2 is 12V and the charging start threshold voltage Vt in the subsequent charging cycle T3 is adjusted to the maximum value of the third voltage segment W3 (i.e., 9V).

At time t5, the input voltage Vin decreases to the charging start threshold voltage Vt (labelled as 525), the charging cycle T3 starts. At time t6, the charging current Ir is stopped, the input voltage control circuit 231 detects the input voltage at time t6, and compares the detected value (labelled as 526) with the charging start threshold voltage Vt (labelled as 525). If value 525 is lower than the value 526, the charging start threshold voltage Vt in a subsequent charging cycle T4 (from t7 to t8) is increased, e.g., adjusted to the maximum value of the second voltage segment W2. The operation process is continuously repeated until the values of the input voltage Vin at the beginning and the end of the charging cycle belong to the same voltage segment.

In the embodiment of FIG. 4, the charging start threshold voltage Vt in the subsequent charging cycle is adjusted based on the charging start threshold voltage Vt in the current charging cycle and the input voltage Vin at the time when the charging current Ir is stopped. In the current charging cycle, if the input voltage Vin at the time when the charging current Ir is stopped is lower than the charging start threshold voltage Vt in the current charging cycle, the charging start threshold voltage Vt in the subsequent charging cycle is decreased. The adjustment range could be equal to a voltage drop of the voltage segment corresponding the current charging cycle. For example, in FIG. 4, the charging start threshold voltage Vt in the charging cycle T1 corresponds to the maximum value of the first voltage segment W1, the charging start threshold voltage Vt in the charging cycle T2 corresponds to the maximum value of the second voltage segment W2, the adjustment range is equal to the voltage drop of the first voltage segment W1.

In some embodiments, the charging start threshold voltage Vt in the subsequent charging cycle is adjusted based on the voltage segments the input voltage Vin at the time when the charging current Ir is stopped and the charging start threshold voltage Vt in the current charging cycle respectively belong to. For example, the charging start threshold voltage Vt in the current charging cycle belongs to the first voltage segment W1, and the input voltage Vin at the time when the charging current Ir is stopped belongs to the fourth voltage segment W4. Thus, the charging start threshold voltage Vt in the subsequent charging cycle is adjusted to the maximum value of the second voltage segment W2. In some embodiments, the charging start threshold voltage Vt is adjusted by steps. In other words, the charging start threshold voltage Vt may be adjusted from the maximum value of the current voltage segment to the maximum value of the adjacent voltage segment (e.g., from W1 to W2).

In some embodiments, the charging start threshold voltage Vt is adjusted by leaps. That is to say, the adjustment range could be one or several times of the voltage drop of one voltage segment, for example, the charging start threshold voltage Vt may be adjusted from the maximum value of the first voltage segment W1 to the maximum value of the fourth voltage segment W4. In other embodiments, the charging start threshold voltage Vt corresponds to the minimum value or any value of the corresponding voltage segment.

In the embodiment shown in FIG. 2, the charging stop signal Rd is provided to the input voltage control circuit 231 for indicating a charging stop time (i.e., the time when the charging current source Is stops providing the charging current Ir). Persons having ordinary skill in the art should be appreciated that, other signals (e.g., the charging control signal Gc) that are capable of indicating the charging stop time could also be provided to the input voltage control circuit 231.

In the embodiments of FIG. 2 and FIG. 4, the voltage comparing circuit 232 includes a comparator and a pulse circuit. The comparator compares the power supply voltage Vcc with the charging stop reference voltage Vccd, and provides a comparing signal based on the comparison result. The pulse circuit receives the comparing signal and provides a pulse signal based on the comparing signal. The pulse signal provides a pulse when the comparing signal indicates that the power supply voltage Vcc increases to the charging stop reference voltage Vccd. In some embodiments, the voltage comparing circuit 232 includes a comparator. The comparator compares the power supply voltage Vcc with the charging stop reference voltage Vccd, and provides the comparing signal to indicate the comparison result. The comparing signal is used as the charging stop signal Rd directly for resetting the RS flip-flop FF1.

In some applications, because of the impact of the post-stage circuit, for example, there is a high resistance in a connection node between the voltage converting control circuit 21 and the input voltage Vin. The waveform shape of the input voltage Vin may be partially consistent with the rectified half-sine wave as shown in FIG. 4. For instance, the waveform shape of the input voltage Vin shows a filtered waveform shape without any voltage valley. In that case, the input voltage Vin is required to be regulated to show the rectified half-sine wave, to ensure the normal operation of the power supply control circuit 22.

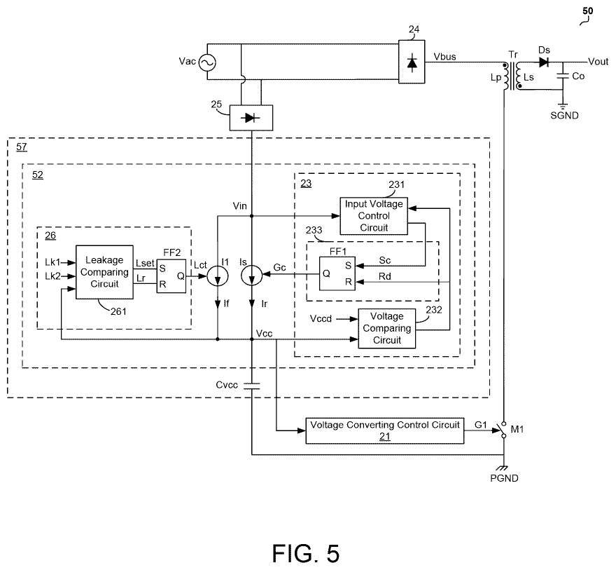

FIG. 5 schematically shows a voltage converting circuit 50 in accordance with an embodiment of the present invention. In the embodiment of FIG. 5, the voltage converting circuit 50 includes a power supply circuit 57. The power supply circuit 57 includes the power supply capacitor Cvcc and a power supply control circuit 52. The power supply control circuit 52 includes the charging current source Is, the charging control circuit 23, a leakage current source 11 and a leakage control circuit 26. The leakage control circuit 26 receives the power supply voltage Vcc, and compares the power supply voltage Vcc with a leakage charging reference voltage Lk1 and a leakage stop reference voltage Lk2. The leakage control circuit 26 provides a leakage control signal Lct to control the leakage current source 11 to start providing a leakage current If for charging the power supply capacitor Cvcc when the power supply voltage Vcc decreases to the leakage charging reference voltage Lk1. The leakage control circuit 26 provides the leakage control signal Lct to control the leakage current source 11 to stop providing the leakage current If when the power supply voltage Vcc increases to the leakage stop reference voltage Lk2.

In the embodiment of FIG. 5, the leakage control circuit 26 includes a leakage comparing circuit 261 and a RS flip-flop FF2. The leakage comparing circuit 261 compares the power supply voltage Vcc with the leakage charging reference voltage Lk1 and the leakage stop reference voltage Lk2, and provides a leakage set signal Lset and a leakage reset signal Lr based on the comparison result. The RS flip-flop FF2 has a set terminal, a reset terminal and an output terminal. The set terminal of the RS flip-flop FF2 is configured to receive the leakage set signal Lset. The reset terminal of the RS flip-flop FF2 is configured to receive the leakage reset signal Lr. The output terminal of the RS flip-flop FF2 is configured to provide the leakage control signal Lct. In one embodiment, the leakage charging reference voltage Lk1 is lower than the leakage stop reference voltage Lk2.

In some embodiments, the leakage comparing circuit 261 may be a hysteresis comparator. In other embodiments, the leakage comparing circuit 261 may include two distinct comparators.

In the embodiment of FIG. 5, the input voltage Vin is pulled down by the leakage current source 11 with a small current. The impact of the internal high resistance and the large parasitic capacitance of the voltage converting control circuit 21 on the input voltage Vin through the power supply voltage Vcc is eliminated. Therefore, the input voltage Vin could maintain the rectified half-sine wave and the power supply control circuit 52 could operate normally.

In some embodiments, the normal operation of the power supply control circuit 22 is realized by setting the charging start threshold voltages Vt of the voltage segments properly. For example, all the voltage segments are set to be higher than a clamp voltage of the input voltage Vin. Even if the input voltage Vin is clamped thus cannot decrease to its lowest point, the power supply control circuit 22 could still operate normally. Consequently, the leakage current source 11 and the leakage control circuit 26 are not necessary.

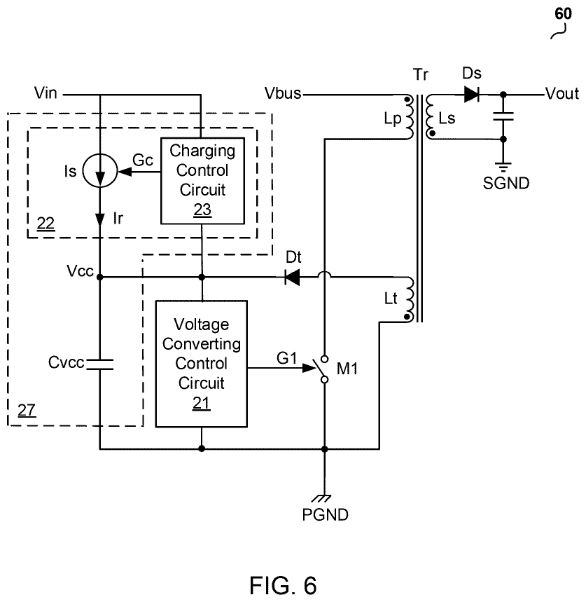

FIG. 6 schematically shows a voltage converting circuit 60 in accordance with an embodiment of the present invention. The voltage converting circuit 60 includes the transformer Tr, the primary switch M1, the secondary switch Ds, the voltage converting control circuit 21 and the power supply circuit 27. The transformer Tr has the primary winding Lp, the secondary winding Ls and an auxiliary winding Lt. The primary switch M1 is coupled to the primary winding Lp. The secondary switch Ds is coupled to the secondary winding Ls. The voltage converting control circuit 21 provides the primary control signal G1 to the control terminal of the primary switch M1, to control the primary switch M1. The voltage converting control circuit 21 is powered by the power supply voltage Vcc. The power supply circuit 27 includes the power supply capacitor Cvcc and the power supply control circuit 22. The power supply control circuit 22 includes the charging control circuit 23 and the charging current source Is. The charging current source Is receives the input voltage Vin and provides the charging current Ir to the power supply capacitor Cvcc for generating the power supply voltage Vcc. The charging control circuit 23 receives the input voltage Vin and the power supply voltage Vcc and provides the charging control signal Gc to control the charging current source Is. When the input voltage Vin decreases to the charging start threshold voltage Vt, the charging control signal Gc controls the charging current source Is to charge the power supply capacitor Cvcc.

In the embodiment of FIG. 6, the auxiliary winding Lt of the transformer Tr is coupled to the charging terminal of the power supply capacitor Cvcc through a diode Dt. When a voltage provided by the auxiliary winding Lt is higher than a maximum voltage of the power supply capacitor Cvcc reached by being charged by the input voltage Vin (i.e., the charging stop reference voltage Vccd), the power supply capacitor Cvcc is charged by the auxiliary winding Lt. Persons skilled in the art could properly set the charging stop reference voltage Vccd and the turns ratio of the auxiliary winding Lt to the secondary winding Ls according to the specifications and requirements of applications. Thereby, in order to maintain the power supply voltage Vcc, when the output voltage Vout is relatively low, the charging control circuit 23 controls the charging current source Is to charge the power supply capacitor Cvcc; and when the output voltage Vout is relatively high, the power supply capacitor Cvcc is charged by the auxiliary winding Lt.

When the output voltage Vout is low, the power supply capacitor Cvcc is charged by the charging current source Is instead of the auxiliary winding Lt, thus high turns ratio of the auxiliary winding Lt to the secondary winding Ls is not necessary. It means the turns ratio of the auxiliary winding Lt to the secondary winding Ls could be 1:1 or 1:2, or even lower. When the turns ratio of the auxiliary winding Lt to the secondary winding Ls is 1:2, even if the output voltage Vout is 20V, the power supply voltage Vcc is 10V. That is to say, when the turns ratio of the auxiliary winding Lt to the secondary winding Ls is low, even if the output voltage Vout is relatively high, the voltage provided by the auxiliary winding Lt is low, thus the voltage converting control circuit 21 does not need to withstand the high voltage. As a result, high voltage devices are not required, and the power dissipation caused by the high voltage is also reduced.

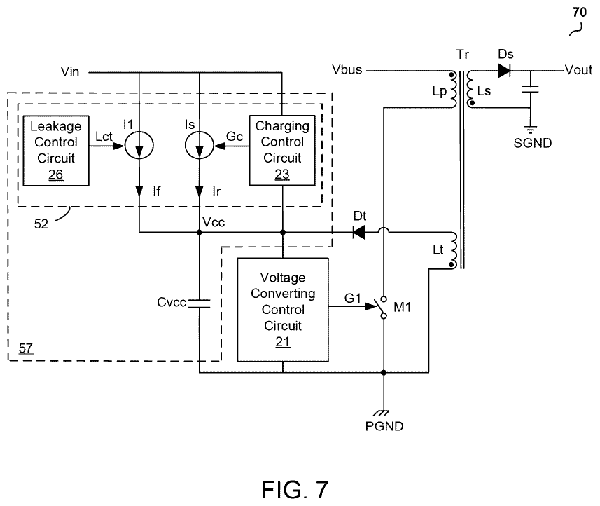

FIG. 7 schematically shows a voltage converting circuit 70 in accordance with an embodiment of the present invention. Compared with the embodiment of FIG. 6, the voltage converting circuit 70 shown in FIG. 7 includes the power supply circuit 57. The power supply circuit 57 includes the power supply control circuit 52. As illustrated herein before, the leakage current source 11 starts providing the leakage current If for charging the power supply capacitor Cvcc when the power supply voltage Vcc decreases to the leakage charging reference voltage Lk1; and the leakage current source 11 stop providing the leakage current If when the power supply voltage Vcc increases to the leakage stop reference voltage Lk2.

It should be appreciated that, the logic circuits in the embodiments of the present invention, for example, the charging control logic circuit 233 and flip-flops FF1 and FF2 just for illustration purposes. The logic circuits could be changed along with the change of the polarity of the input/output signal of the logic circuits.

The voltage converting circuits 20, 50, 60, and 70 have a FLYBACK topology in the embodiments of the present invention. It should be appreciated that, the voltage converting circuits 20, 50, 60, and 70 could have other topologies, e.g., BUCK topology and BOOST topology. The power supply control circuit in the embodiments of the present invention could also be utilized in other voltage converting circuits having different topologies.

In some embodiments, some or all of the charging control circuit 23, the leakage control circuit 26, the charging current source Is, the leakage current source 11 are integrated with the voltage converting control circuit 21 in an integrated circuit, and the power supply voltage Vcc could be used for powering the integrated circuit. In one embodiment, the charging current source Is includes a switch. A control terminal of the switch is configured to receive the charging control signal Gc.

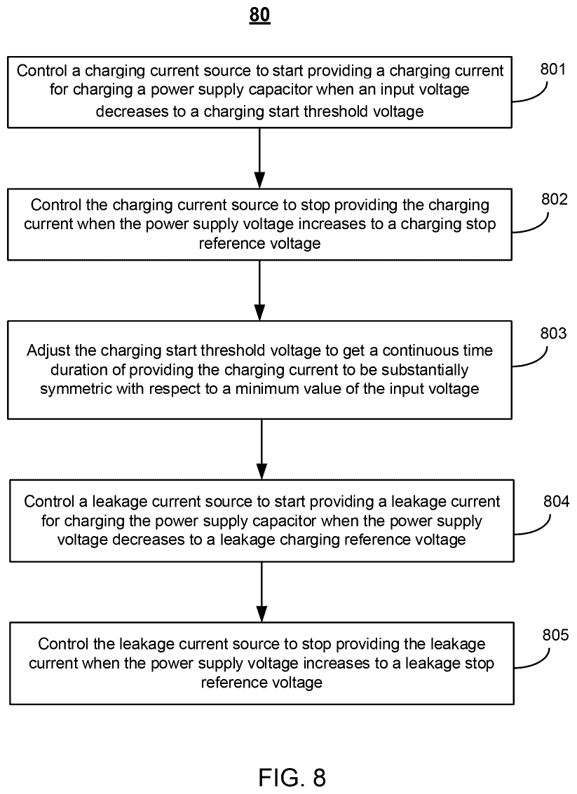

FIG. 8 schematically shows a flowchart of a method 80 of controlling a power supply voltage in accordance with an embodiment of the present invention. The method 80 may be used to control a charging current source to charge a power supply capacitor for generating a power supply voltage to power an integrated circuit. In some embodiments, the integrated circuit may include the voltage converting control circuit 21 as shown in FIG. 2 and FIGS. 5-7. The charging current source receives an input voltage and provide a charging current to the power supply capacitor for generating the power supply voltage. The input voltage is received from an AC power supply through a rectifying circuit. The AC power supply provides an AC voltage having a sine wave, thus the waveform shape of the input voltage shows a rectified half-sine wave. The method 80 includes steps 801-803.

In step 801, the charging current source is controlled to start providing the charging current for charging the power supply capacitor when the input voltage decreases to a charging start threshold voltage. In step 802, the charging current source is controlled to stop providing the charging current when the power supply voltage increases to a charging stop reference voltage. In step 803, the charging start threshold voltage is adjusted to get a continuous time duration of providing the charging current to be substantially symmetric with respect to a minimum value of the input voltage. In some embodiment, the charging start threshold voltage is adjusted based on the input voltage at the time when the charging current is stopped.

In one embodiment, the step 803 includes the following steps. The charging start threshold voltage is compared with the input voltage at the time when the charging current is stopped. The charging start threshold voltage is decreased when the charging start threshold voltage is higher than the input voltage at the time when the charging current is stopped. The charging start threshold voltage is increased when the charging start threshold voltage is lower than the input voltage at the time when the charging current is stopped.

In some embodiments, the step 803 includes the following steps. A plurality of non-overlapped voltage segments are determined based on the input voltage. Which voltage segments the input voltage at the time when the charging current is stopped and the charging start threshold voltage respectively belong to are determined. The charging start threshold voltage is adjusted if the determined voltage segments are different from each other. In one embodiment, the plurality of voltage segments is provided based on a peak value of the input voltage.

In some embodiments, the charging start threshold voltage is a maximum value of a corresponding voltage segment.

In one embodiment, a leakage current source is coupled between the input voltage and the power supply capacitor, and the method 80 further includes steps 804-805.

In step 804, the leakage current source is controlled to start providing a leakage current for charging the power supply capacitor when the power supply voltage decreases to a leakage charging reference voltage. In step 805, the leakage current source is controlled to stop providing the leakage current when the power supply voltage increases to a leakage stop reference voltage.

The method 80 illustrated above could be performed in different orders.

In one embodiment, the leakage stop reference voltage is higher than the leakage charging reference voltage.

In one embodiment, the leakage stop reference voltage is equal to the charging stop reference voltage.

It should be understood, the circuit and the workflow given in the present invention are just for schematic illustration. Any circuit can realize the function and operation of the present invention does not depart from the spirit and the scope of the invention.

While specific embodiments of the present invention have been provided, it is to be understood that these embodiments are for illustration purposes and not limiting. Since the invention can be practiced in various forms without distracting the spirit or the substance of the invention. It should be appreciated that the above embodiments are not confined to any aforementioned specific detail but should be explanatory broadly within the spirit and scope limited by the appended claims. Thus, all the variations and modification falling into the scope of the claims and their equivalents should be covered by the appended claims.

What is claimed is:

1. A control circuit for controlling a power supply voltage of an integrated circuit, comprising:
a charging current source configured to receive an input voltage and to provide a charging current to a power supply capacitor for generating the power supply voltage; and wherein
the charging current source is configured to start providing the charging current for charging the power supply capacitor when the input voltage decreases to a charging start threshold voltage and to stop providing the charging current when the power supply voltage increases to a charging stop reference voltage; and wherein
the charging start threshold voltage is adjusted to get a continuous time duration of providing the charging current to be substantially symmetric with respect to a minimum value of the input voltage.

2. The control circuit of claim 1, wherein the charging start threshold voltage is adjusted based on the input voltage at the time when the charging current is stopped.

3. The control circuit of claim 1, wherein a plurality of non-overlapped voltage segments are determined based on the input voltage; and wherein:
which voltage segments the input voltage at the time when the charging current is stopped and the charging start threshold voltage respectively belong to are determined, and if the determined voltage segments are different from each other, the charging start threshold voltage is adjusted.

4. The control circuit of claim 3, wherein the charging start threshold voltage is a maximum value of a corresponding voltage segment.

5. The control circuit of claim 1, further comprising:
a charging control circuit configured to provide a charging control signal for controlling the charging current source based on the input voltage and the power supply voltage.

6. The control circuit of claim 5, wherein the charging control circuit comprises:
an input voltage control circuit configured to provide a charging set signal based on the input voltage;
a voltage comparing circuit configured to provide a charging stop signal based on the power supply voltage and the charging stop reference voltage; and
a charging control logic circuit configured to provide the charging control signal to control the charging current source based on the charging set signal and the charging stop signal.

7. The control circuit of claim 1, further comprising:
a leakage control circuit configured to provide a leakage control signal based on the power supply voltage, a leakage charging reference voltage and a leakage stop reference voltage;
a leakage current source coupled in parallel with the charging current source, and configured to provide a leakage current to the power supply capacitor based on the leakage control signal; and wherein
the leakage control signal is configured to control the leakage current source to start providing the leakage current for charging the power supply capacitor when the power supply voltage decreases to the leakage charging reference voltage and to control the leakage current source to stop providing the leakage current when the power supply voltage increases to the leakage stop reference voltage.

8. The control circuit of claim 7, wherein the leakage stop reference voltage is equal to the charging stop reference voltage.

9. A power supply circuit for providing a power supply voltage of an integrated circuit, comprising:
a power supply capacitor having a charging terminal; and
a control circuit coupled to the charging terminal of the power supply capacitor, and configured to control the power supply voltage, comprising:
a charging current source configured to receive an input voltage and to provide a charging current to the power supply capacitor for generating the power supply voltage; and wherein
the charging current source is configured to start providing the charging current for charging the power supply capacitor when the input voltage decreases to a charging start threshold voltage and to stop providing the charging current when the power supply voltage increases to a charging stop reference voltage; and wherein
the charging start threshold voltage is adjusted to get a continuous time duration of providing the charging current to be substantially symmetric with respect to a minimum value of the input voltage.

10. The power supply circuit of claim 9, wherein the charging start threshold voltage is adjusted based on the input voltage at the time when the charging current is stopped.

11. The power supply circuit of claim 9, wherein a plurality of non-overlapped voltage segments are determined based on the input voltage; and wherein:
which voltage segments the input voltage at the time when the charging current is stopped and the charging start threshold voltage respectively belong to are determined, and if the determined voltage segments are different from each other, the charging start threshold voltage is adjusted.

12. The power supply circuit of claim 11, wherein the charging start threshold voltage is a maximum value of a corresponding voltage segment.

13. The power supply circuit of claim 9, wherein the charging terminal of the power supply capacitor is coupled to an auxiliary winding of a transformer of a voltage converting circuit through a diode.

14. A method of controlling a power supply voltage, comprising:
controlling a charging current source to start providing a charging current for charging a power supply capacitor when an input voltage decreases to a charging start threshold voltage;
controlling the charging current source to stop providing the charging current when the power supply voltage increases to a charging stop reference voltage; and
adjusting the charging start threshold voltage to get a continuous time duration of providing the charging current to be substantially symmetric with respect to a minimum value of the input voltage.

15. The method of claim 14, wherein the charging start threshold voltage is adjusted based on the input voltage at the time when the charging current is stopped.

16. The method of claim 15, wherein the step of adjusting the charging start threshold voltage comprises:
comparing the charging start threshold voltage with the input voltage at the time when the charging current is stopped;
decreasing the charging start threshold voltage when the charging start threshold voltage is higher than the input voltage at the time when the charging current is stopped; and
increasing the charging start threshold voltage when the charging start threshold voltage is lower than the input voltage at the time when the charging current is stopped.

17. The method of claim 14, wherein the step of adjusting the charging start threshold voltage comprises:
determining a plurality of non-overlapped voltage segments based on the input voltage;
determining which voltage segments the input voltage at the time when the charging current is stopped and the charging start threshold voltage respectively belong to; and
adjusting the charging start threshold voltage if the determined voltage segments are different from each other.

18. The method of claim 17, wherein the charging start threshold voltage is a maximum value of a corresponding voltage segment.

19. The method of claim 14, wherein:
controlling a leakage current source to start providing a leakage current for charging the power supply capacitor when the power supply voltage decreases to a leakage charging reference voltage; and
controlling the leakage current source to stop providing the leakage current when the power supply voltage increases to a leakage stop reference voltage.

20. The method of claim 19, wherein the leakage stop reference voltage is higher than the leakage charging reference voltage.
